(19) United States
(12) Patent Application Publication
(10) Pub. No.: US 2016/0073253 A1
(43) Pub. Date: Mar. 10, 2016

(54) Method and System for inhibiting access to a device in a moving vehicle

(71) Applicants: Andrew M. Grodin, Livingston, NJ (US); James A. Hill, Westfield, NJ (US)

(72) Inventors: Andrew M. Grodin, Livingston, NJ (US); James A. Hill, Westfield, NJ (US)

(21) Appl. No.: 14/476,815

(22) Filed: Sep. 4, 2014

(51) Int. Cl. H04W 8/22

(52) U.S. Cl. CPC H04W 8/22

(57) ABSTRACT

A system and method for inhibiting certain functionality of a personal communications device within a moving vehicle is disclosed. The disabled functionality is limited to the personal communications device of the operator of the vehicle and will not disable functionality of personal communication devices of other passengers within the vehicle.

### BACKGROUND

### Technical Field

The present teaching relates to methods and systems for inhibiting an input portion of a device during certain operating conditions. More specifically, the present methods and system relate to inhibiting texting and keyboard input of a Smartphone, tablet, laptop, or other PDA while operating a moving vehicle.

The proliferation of smart phones, mobile phones, laptops, tablets, microcomputers, and PDAs has made today's society more and more dependant on mobile communication and access to instant information. This includes, the explosion in the number of voice calls, e-mails, short messages, i.e., Tweets, social media updates, and texts we receive on our mobile devices throughout our daily lives. This constant barrage of information does not cease simply because the users are involved in their daily activities, including driving and operating other moving vehicles. Studies have shown that accessing such mobile devices, to send and/or respond to this constant barrage of information can often be distracting to the operator of a motor vehicle and often extremely dangerous. While educational efforts are in place to educate the public about the danger of “texting and driving” such education is not enough to ensure safe operation of motor vehicles by those engaged in such reckless conduct. This problem is not confined to “texting” per se, but applies equally to any behaviors that require the operator of a moving vehicle to take their attention away from operating the vehicle to check, read, or respond to information received on their device.

While such behavior is a problem for anyone who operates a motor vehicle, the problem seems to be most prevalent in younger drivers who have always had access to such devices and who therefore rely on such devices for constant communication and information. A simple solution to such a problem would be an application on a device that senses when it is in motion and automatically inhibits the user from accessing the devices key board. Such a system however, would prohibit not only the driver, but the passenger in a moving vehicles from operating their devices. A user could inhibit such an application and easily defeat such a solution. Another solution might be a parent who wishes to prohibit their children from “texting and driving” sends a command from a separate device to a user's device that inhibits access to the keyboard or input device while the child operates the motor vehicle. This solution would only be effective if the parent knew exactly when the user was operating the vehicle. Accordingly, a need exists for a system and method that prohibits the use of a device in a moving vehicle for a driver without interfering with user's who are not operating the vehicle. Further a need exists for a system and method that does not require third party input to inhibit the use of a device in a motor vehicle. The present disclosure addresses these needs.

### SUMMARY

In an embodiment, a method for inhibiting functionality of a personal communications device of a user within a moving vehicle described, The method comprising determining, via a user identification device, if the user is in proximity to the vehicle; obtaining, from the user identification device, user personal information associated with the user; determining, based on the user personal information, if the user is operating the vehicle; associating, based on the obtained information, the user with the user's personal communications device; communicating, via a communications interface, with the user's communications device; determining if the user's communications device is in motion; and inhibiting, via a client installed on the user's communications device, operation of certain features of the user's communication device based on the determining.

In another embodiment, a system for inhibiting functionality of a personal communications device of a user within a moving vehicle is disclosed. The system comprising user identification device comprising user personal information; a user identification module within the vehicle for obtaining the user's personal information; a processor for determining if the user is operating the moving vehicle; a transmitter/receiver for transmitting/receiving information to/from the vehicle and the user's personal communications device; a client installed on the user's communications device for inhibiting functionality on the personal communications device.

### BRIEF DESCRIPTION OF DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a system for disabling a communications device within a vehicle in accordance with an embodiment of the present disclosure.

FIG. 2 depicts a flow chart for the system in accordance with an embodiment of the present disclosure.

FIG. 3 depicts the flow on the user's communications device in accordance with the present disclosure

FIG. 4A depicts the information flow for a user identification device in accordance with an embodiment of the present disclosure.

FIG. 4B depicts the information flow for a user identification device in accordance with an embodiment of the present disclosure.

FIG. 4C depicts the information flow for a user identification device in accordance with an embodiment of the present disclosure.

FIG. 5A is a representation of a user identification module in an embodiment of the present disclosure.

FIG. 5B is a representation of a user identification module in an embodiment of the present disclosure.

FIG. 6A is a representation of a passive user identification tag or fob in accordance with an embodiment of the present disclosure.

FIG. 6B is a representation of an active user identification tag or fob in accordance with an embodiment of the present disclosure.

FIG. 7 is a representation of a user identification module in an embodiment of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The systems and method disclosed herein make reference to vehicles and smart phones. It is to be understood however, that vehicle is not limited to automobiles and may include trucks, boats, planes, trains, and any other moving vehicle. Likewise the term Smartphone is generically used for devices that allow for two way communications with keypad input from the user. Such devices include mobile phones, Smartphones, PDA, tablets, laptops, microcomputers, or any other communication device that may be operated in a moving vehicle. Furthermore, input is not limited to traditional keyboard entries but may also include devices that embody visual typing, voice recognition, touch screen built in key boards, and the like.

The present disclosure relates to a system and method that utilizes an operator identification unit that identifies the operator of the moving vehicle as opposed to a passenger in the vehicle and conveys that information to a communications device related to that operator. In an embodiment, an operator identification unit may be a stand alone device such as a key fob used by a driver or it may be an identification unit built into the vehicle itself.

It has become more and more common for vehicles to require the operator to carry a key fob or smart keys which actively or passively transmit information to the vehicle when the key fob or smart key is within the vehicle or within a specific distance of the vehicle. Smart keys allow drivers to keep the key fob in their pocket when unlocking, locking and starting the vehicle. The key is identified via one of several antennas in the vehicles bodywork and a RF, infrared, sonic, sub sonic or ultra sonic, pulse generator in the key housing. Depending on the system, the vehicle may be automatically unlocked when a button or sensor on the door handle or trunk release is pressed.

Many vehicles with smart key systems allow the activation of the ignition without inserting a traditional key in the ignition, thereby providing the driver has a key inside the car. On many vehicles, this is done by pressing a starter button or twisting an ignition switch. When leaving a vehicle equipped with a smart key system, the vehicle is locked by either pressing a button on one of the door handles, touching a capacitive area on a door handle, or by simply walking away from the vehicle.

Furthermore, some vehicles may automatically adjust settings based on the smart key used to unlock the car: user preferences such as seat positions, steering wheel position, exterior mirror settings, climate control temperature settings, and stereo presets are popular adjustments. Some models have settings which can prevent the vehicle from exceeding a maximum speed when a certain key is used to start it.

In the present system, the smart key or fob is enhanced to allow identification of the specific fob or smart key user and their respective personal communication device. In an embodiment, the operator's personal communications device such as a smartphone is synched or keyed to the fob or smart key. With such a synched system, in an embodiment, when the smart key or fob is within the vehicle and the vehicle is in operation, i.e., the engine is running, a signal is transmitted via wireless communication such as RF, Bluetooth™, infrared, sonic, audible or any other near field or short distance communications protocol, informing the communications device that the vehicle is in operation.

The communications protocol should be primarily designed for low power consumption, with a short range (power-class-dependent, but effective ranges vary in practice; see table below) based on low-cost transceiver microchips in each device. Because the devices use a radio (broadcast) communications system, they do not have to be in visual line of sight of each other, however a quasi optical wireless path must be viable.

In an embodiment, the communication device may have a built in accelerometer or GPS receiving device and may be able to determine if the device is in motion and/or exceeding a predetermined speed threshold. If the communications device determines that it is in motion and the communications device is receiving a signal from the operator's fob synched to that indicating that the vehicle is in operation, then the keypad and/or other functionality of the communications device such as texting or e-mailing is disabled. In this manner the operator is unable to access the keypad or other functionality of the communications device while operating the vehicle and the vehicle is in motion.

In an embodiment, the communications device may be operated when the vehicle is not in motion for a set period of time despite the vehicle being in a running condition. This may occur for example, when the vehicle is idling but not moving. Because the communications device itself can sense if it is motion, it can determine when it is safe to operate the keypad of the communications device from within a running vehicle.

In an embodiment, the vehicle itself may have an operator identification device, such as a keypad to enter a user id or a biometric sensor such as fingerprint reader, facial recognition sensor, voice recognition sensor, or other biometric identifier. Such an operator identification device may be coupled to a processor and transmitter that communicates with the communication device once it is inside the vehicle.

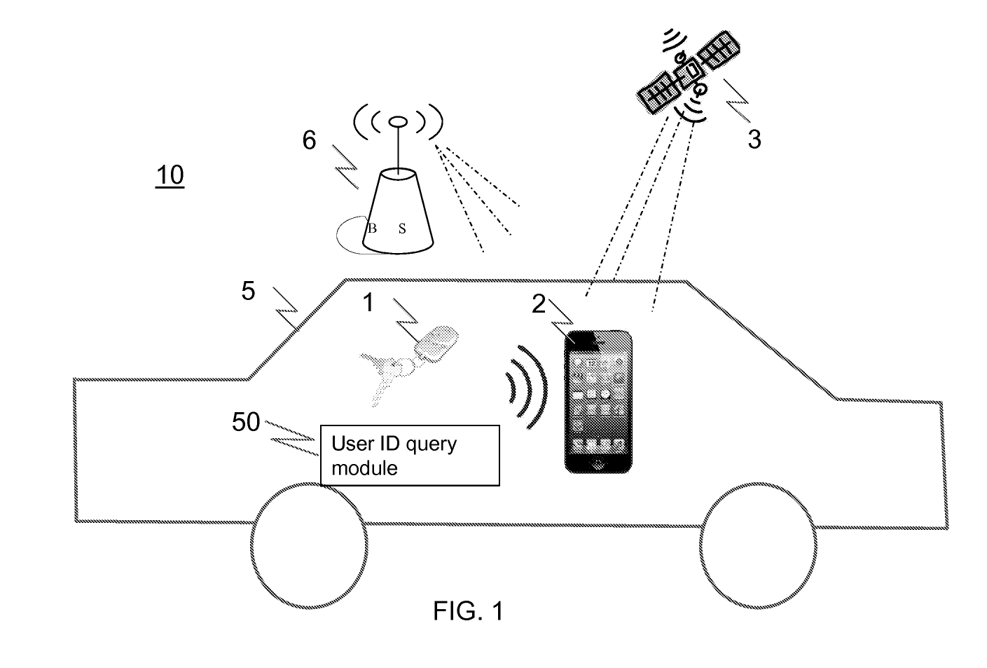

FIG. 1 depicts an overview of system 10 of the present disclosure. System 10 comprises user identification module 1, personal communications device 2, positioning signal 3, user identification query module 50 and vehicle 5. As will be understood by one skilled in the art, additional or fewer components may be implemented or consolidated into different devices without departing from the present disclosure. Identification (ID) module depicted in FIG. 1 is a key fob or smart key. Additionally and/or alternatively, ID module 1 may be integrated into vehicle 5 as a user identification device such as a keypad or biometric sensor. ID Module 1 may comprise a memory, a processor, a transmitter/receiver, an interrogator and may be capable of transmitting and/or receiving signals to/from vehicle 5, transmitter 11 or receiver 4 of user identification query module 50, and/or to/from communications device 2. In addition to being able to transmit and/or receive signals, ID module 1 is capable of identifying and/or providing the identity of the user of communications device 2 as well as transmitting and receiving other signals between the various components of system 10.

In an example, a user associated with communications device 2 enters vehicle 5. The user may use ID module 1 to start an engine in vehicle 5 or ID module 5 may simply be on the user's person and the vehicle may be started using a traditional key or other device. ID module 1 may contain information about the user and the communication device 2. Once the engine of vehicle 5 is started, ID module 1 may receive a signal from the transmitter/receiver of user identification query module 50 indicating that the engine is started. Additionally/and or alternatively, ID module 1 may receive a signal directly from vehicle 5 indicating that the engine has been started and or is energized.

ID module 1 may then transmit a signal directly to communications device 2 indicating that the vehicle has been started. Additionally and/or alternatively, transmitter 11 or receiver 4 of user identification query module 50 may communicate information directly to communications device 2 regarding the status of vehicle 5. Once communications device 2 receives the signal from the ID module 1, it launches application 2A installed on communications device 2.

Prior to operation, communications device 2 downloads an application 2A (not shown) that may be obtained through any form of application portal such as iTunes™ or Google Play™ for example. Additionally and/or alternatively, application 2A may come preloaded on device 2 or may be integrated into the operating system of device 2. Application 2A once installed on communications device 2 has the ability to disable certain functionality of communications device 2 and inhibit the use of other applications and/or functions previously installed on device 2.

In an embodiment, application 2A may allow for user profile information, such as a user ID, a user communication device ID, an emergency override option setting, a speed setting, a vehicle ID setting. All this information may be set up and/or created on the user communication device 2 or may be preset using any other communications device such as a computer or tablet. In an embodiment, the profile information may be password protected so that it may not be changed by the communication device user. In an embodiment, application 2A could not be deleted from device 2 without a password. In this manner a user may not override or frustrate the purpose of the disclosure by simply removing application 2A. Other parameters that might be set in the user profile include a speed threshold, a delay threshold, a time of day setting, a route setting, or any others. The speed threshold for example might allow the user to operate all the functionality of the communication device 2 below a certain speed when inside the vehicle. The delay threshold may reactive the full functionality of the communication device 2 after it is determined that the deice is no longer in motion for a fixed period of time. The time of day setting may allow all functionality only during certain hours and the route setting might allow use of functions based on the road type. These are just a few setting envisioned and those skilled in the art would appreciate that there may be others.

Once application 2A launches, it remains inactive until such time as communications device 2 receives a signal indicating that it should activate. Such activation may occur, for example, when communication device 2 receives a signal indicating a condition such as motion or if the device itself determines that it is in motion. The determination of motion may be perceived by a signal generated within communications device 2 or received from vehicle 5 indicating that vehicle 5 is in motion. Communications device 2 may have a built in accelerometer or some other type of sensor altering it to the fact that it is in motion and allowing it to determine a rate of speed. Additionally and/or alternatively, communications device 2 may receive an external signal from communications system 3, which may be a satellite, such as a GPS network or it may be another form of communications system such as a cellular network. Such cellular or wireless networks may transmit signals in any format capable of being received by Communications device 2, such as CDMA, TDMA, FDMA, SSMA, GSM, PCS. GPRS, CSD, EDGE, UMTS, LTE, 3G, 4G, 3GLTE, cellular, AMPS, or any other wireless standard.

Once device 2 detects it is in motion within vehicle 5, application 2A resident on communications device 2 activates and disables certain functionality or applications resident on communications device 2. For example, all keypad functionality could be disabled, or screen viewing could be disabled. Texting features or e-mail features could be disabled when the application activates. Additionally and/or alternatively, some features may remain active, such as telephone features, camera features, voice recognition features, music features or any other functionality that does not divert the operators attention from controlling vehicle 5.

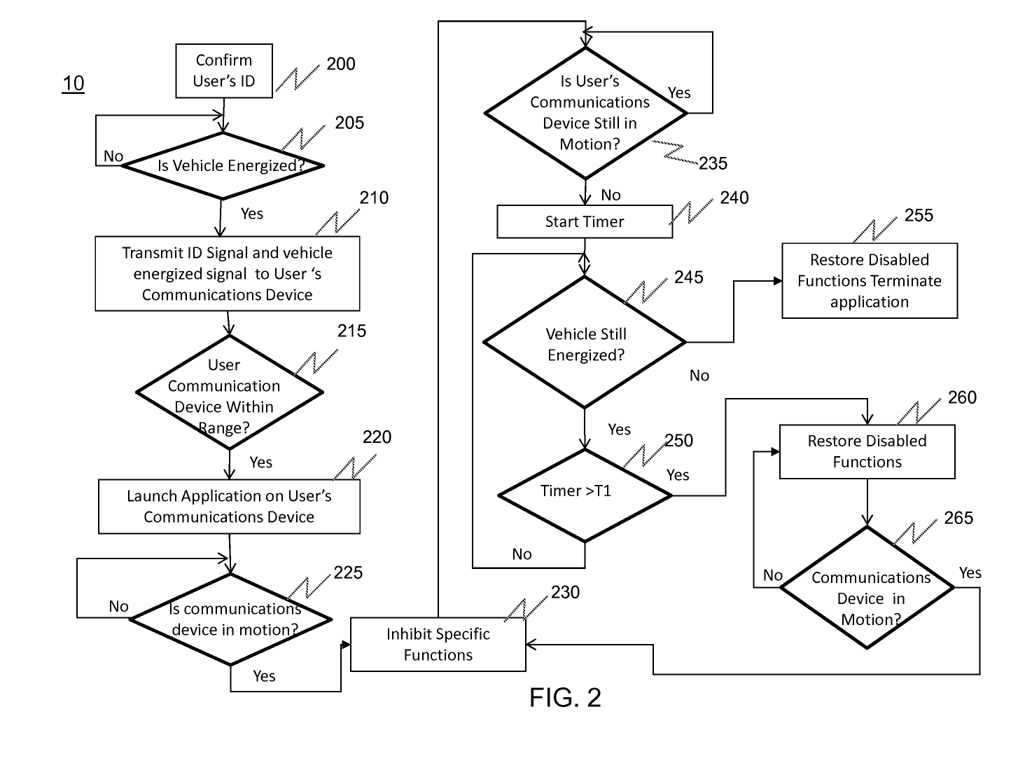

FIG. 2 depicts the flow chart system 10 in accordance with an embodiment of the present disclosure. At step 200, system 10 determines the vehicle user's identification via ID module 1. ID module 1 may be a smart key or fob that contains information about the user within its memory or it may contain other user ID information such as a user number, or password identified with that specific user. Once within range of vehicle 5, ID module 1 may transmit that user ID information to a processor within vehicle 5 which allows vehicle 5 to be started. Additionally and/or alternatively, vehicle 5 may have an ID module built into it, such that the user enters some form of user ID or password, via a key pad or other biometric sensor which identifies the user as authorized to operate vehicle 5.

If the user's ID is confirmed, the user may start or energize the vehicle at step 205. If the user starts vehicle 5 using either user ID module 1 or any other mechanism including a password or key, then a signal linked to the user's ID may be transmitted to the user's communication device 2 at step 210. The ID signal may originate with the ID module 1 or may be transmitted directly from the vehicle 5 via the transmitter/receiver of user identification query module 50. If the ID module 1 is a stand alone smart key or fob, it may convey the ID signal directly via any known short range communications standard such as Bluetooth™, or any other dedicated short-range communications standard which may be one-way or two-way short- to medium-range wireless communication channels. The communications may be specifically designed for automotive or in vehicle use and may correspond to a set of designated protocols and standards. The communications may operate within any frequency band including within the 2.4 GHz short-range radio frequency band. It may use any radio technology including frequency-hopping spread spectrum or any simple packet transmission. The transmitted data may be divided into packets and transmitted on one of several designated channels.

Once the ID signal transmitted at step 210 is broadcast, if the user's communications device 2 is within range at step 215, the system continues. If the user's communications device 2 is not within range of the transmitted signal, i.e., it is not within vehicle 5, then there is no reason for the process to proceed. If however, the communications device receives the specific ID signal at step 220, application 2A previously installed on device 2 is launched. Application 2A may remain inactive until step 225 when a determination is made as to whether communications device 2 is in motion.

In the manner the only communications device effected will be the one associated with the user's ID, i.e., communication device 2. Other communication devices located within vehicle 5 and within the range of the ID signal transmitted at step 210, such as those within the possession of passenger will not launch applications 2A.

The determination of motion may be generated within communications device 2 itself, via an accelerometer or other sensor such as a magnetometer, or pendulum device that may sense motion. Alternatively, communications device 2 may receive a signal from vehicle 5 indicating that the vehicle is in motion. Additionally and/or alternatively, in an embodiment, communication device 2 receives a signal from a wireless or satellite network such as GPS which allows it to detect that it is in motion. Once it is determined that communications device 2 is in motion at step 225, application 2A, which may be inactive activates and inhibits specific functionality on the communications device 2.

In an embodiment, application 2A does not activate until a specific speed threshold is achieved or exceeded. For example, if motion is detected but the speed is less then the preset threshold identified in the application 2A or in the user's profile, the application will remain inactive. In this manner, the user may still use the communications device while operating vehicle 5 but only when the vehicle's speed would not result in a serious danger to the user and/or others within the vicinity. The threshold could be set to zero or a maximum of 3-5 miles per hour. While operating a vehicle while distracted is never recommended, there may be situations where a driver may wish to use the communications device 2 inside the vehicle at a relatively slow rate of speed. This threshold could be preset or may be associated with the user ID.

Once functionality of user device 2 is inhibited at step 230, the system periodically checks to determine if the vehicle is still in motion at step 235. The checking period could be anywhere from a few milliseconds to every second or longer. If it is determined at step 235 that the communication device 5 is still in motion, above any predetermined threshold, then the system continues to recheck until this changes. If it is determined at step 235 that the device is no longer in motion, then at step 240, a timer is started. The timer will determine how long the communications device has not been in motion.

At step 245 it is determined if the vehicle is still energized. This may be determined based on the signal generated at step 210. If the vehicle is no longer energized, i.e., the engine has been switched off, the at step 255 the functionality of udder communication device is restored and application 2A may self terminate. In an embodiment, application 2A could be terminated by the user once the communications device 2A no longer received the signal indicating that the vehicle was energized. In this manner resources on communication device 2 are freed up once the vehicle 5 is no longer operating.

If however, at step 245, it is determined that the vehicle is still energized, then at step 250 the timer value is compared to a preset threshold T1 to determine how long vehicle 5 and accordingly the user communication device 2 has been stationary. If the timer value exceeds T1, the functionality of device 2 is restored at step 260.

In this embodiment, if the vehicle is idling parked for example the user will have access to all functions on the communication device 2. Similarly, if the user is stuck in traffic and no longer moving, then the functionality of the communications device 2 will be restored.

In this embodiment however, if at step 265, the system determines that communications device 2 is once again in motion, the system will return to step 230 and the functionality on communications device 2 will be inhibited.

In an embodiment, an override function may interrupt the process at any time and allow the user emergency access to the full functionality of the communications device. Such emergency overrides may include but not be limited to a series of unique key strokes or button depressions depending on the device. In an embodiment, if the emergency override functionality is engaged, a text-message, e-mail, phone call or other communications may be transmitted to a pre-identified person alerting them to the fact that the override function has been engaged at a time when communications device 2 was within a moving vehicle being operated by the user of the communications device.

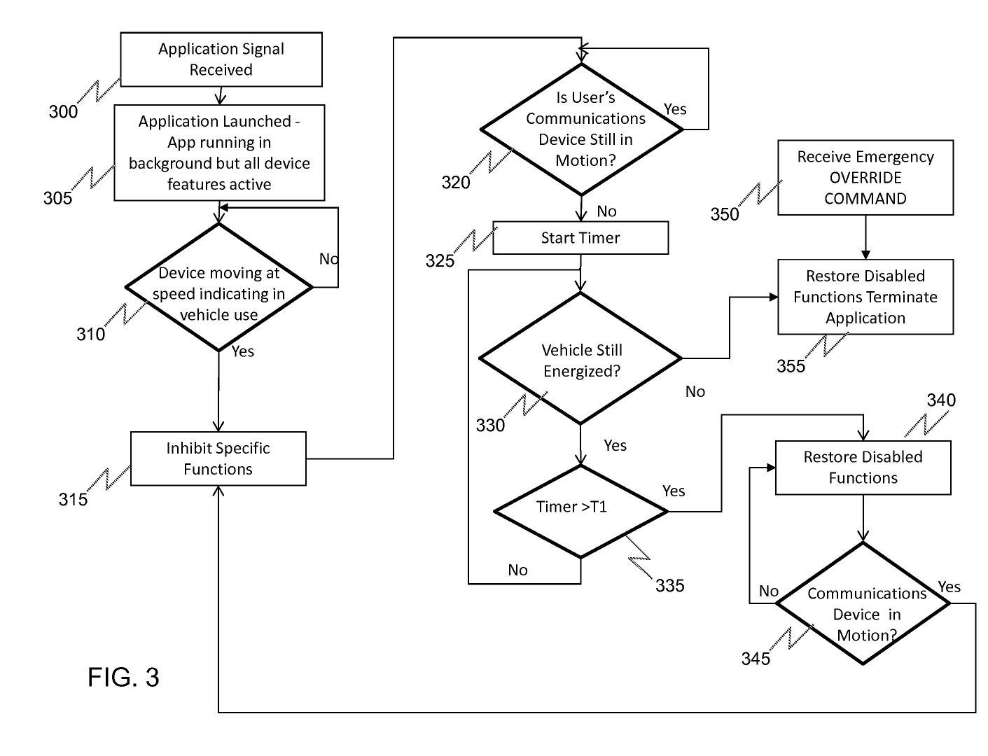

FIG. 3 depicts the instructions run on the communications device. At 300, the communications device receives a signal indicating that the vehicle is energized and the device is within the proximity of the vehicle. At step 305, the application to inhibit certain features is launched but all device functionality remains active. The communications device will remain in this state as long as there is no indication that the device is in motion. If at step 310 motion of the device above a set threshold is detected, specific functionality of the device may be inhibited at step 315. The detection of motion of the device at step 310 may be accomplished by a sensor or signal received or generated within the device itself, such as a received GPS signal indicating that the device is in motion, an accelerometer, or some other sensor. Additionally, and or alternatively, the vehicle may send a signal using the near field communications link indicating to the communications device that the vehicle is in motion.

At step 320, based on a received signal or a determination within the device, the device will determine if the device is in motion. If the device is in motion, it remains inhibited. If however, it is determined that the device is no longer in motion, a timer at step 325 is started. If the device receives a signal that the vehicle is still energized at step 330, then the timer will increment at step 335. If at step 330 it is determined that the vehicle is no longer energized, them all functionality is restored to the device at step 355. As long as the vehicle is energized and timer T1 is less then some predetermined threshold the device will be inhibited. If however at step 335, the time exceeds threshold T1, then the communication device functionality is restored at step 340. In this manner, if the vehicle stops but remains running, the functionality will be restored after a predetermined period of time. This would allow the user to use the communications device when parked, waiting, or pulled over on the side of the road without having to turn off the vehicle ignition. Additionally and/or alternatively, T1 could be set to a period to allow the user to use the device while stopped at a red light if desired. It is understood, that as soon as device/vehicle motion were detected at step 345, the functionality would be inhibited.

Additionally, if an emergency situation arose where the operator of the vehicle needed to use the device and or could not wait for the timer T1 to expire, an emergency override command could be entered at step 350. If the emergency override command was entered, all device functionality would be restored. Additionally and/or alternatively, when an override command was entered at step 350, a text message could be sent to a third party device indicating that the override function had been input. In this manner, a parent or guardian could be notified that the functionality was overridden. Further, a message could be transmitted to the third party indicating the functionality being used as well as the time, vehicle speed and location. This information could be generated by the communications device alone or in combination with information furnished by the device.

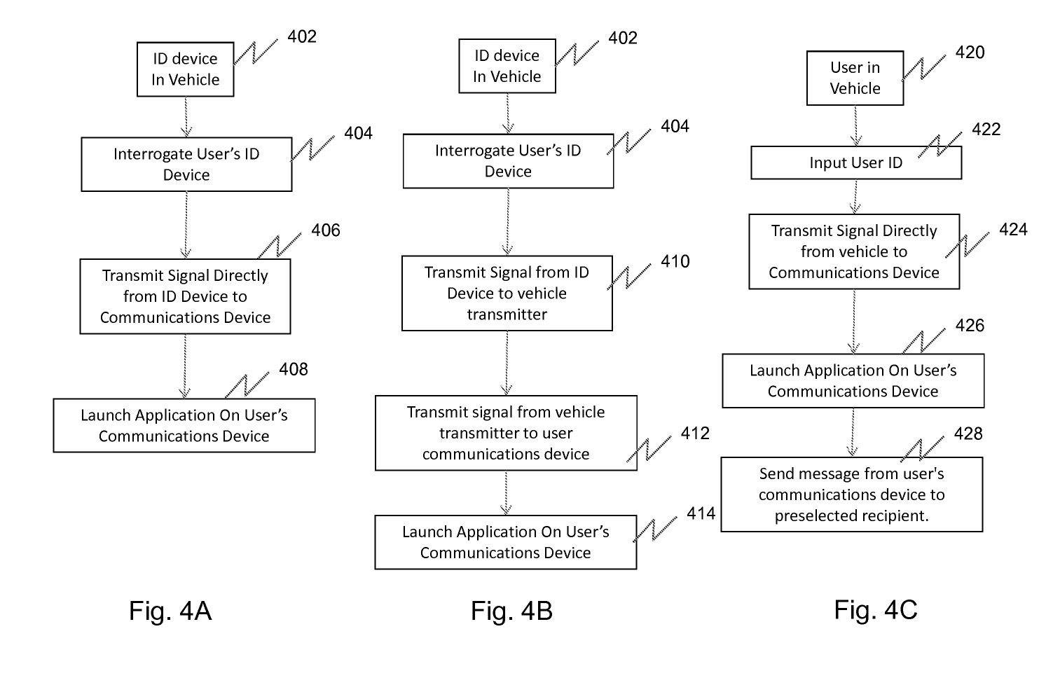

FIG. 4A-C depict embodiments of different ID methods in accordance with the present disclosure. FIG. 4A depicts the use of a user ID device used in accordance with an embodiment of the present disclosure. At step 402 a user enters vehicle 5 with a user ID module 1. The user ID module 1 may be an unpowered device such as an RFID. The unpowered device may be in the form of a separate card or may be integrated in to the user's keys or key fob. The ID device may be in the form of a smart key or other device. The ID device may be used to start the vehicle as well as used to identify the user alternatively, it may be just a fob that is necessary to start the vehicle but does not physically interact with the vehicle. The ID device of step 402 will be programmed with information about the user including but not limited to information about the user's communication device 2. Once the user enters vehicle 5 with the unpowered device, the device may be interrogated at step 404. The interrogation of the ID device 1 may include placing the device within proximity of a RF or magnetic field which may induce a signal within the ID module 1. With the ID module 1 within the interrogator field, the ID module at step 406 may transmit a signal directly to the communications device 2. The signal should require low power and should ideally be contained within the vehicle. The signal may be transmitted on any specified frequency, preferably on some common standard, such as Bluetooth™ or other readily available short range communications link. At step 408, communication device 2 receives the signal and launches application 2A.

In another embodiment, depicted in FIG. 4B the user enters vehicle 5 with the ID module and steps 402 and 404 are repeated. At step 410 however, in an embodiment, the ID Module 1 transmits the user ID information to vehicle transmitter/receiver of user identification query module 50 rather than directly to communications device 2. In this manner, a lower power signal may be transmitted, that contains only user ID information in response to the interrogation of the user ID module at, secure location, such as an office. The user may place the user ID module 1 in close proximity to an interrogator within vehicle 5 which energizes circuitry within the user ID module 2. Once energized, the User ID module conveys the stored user ID information to a processor within the vehicle 5. At step 412, once the vehicle 5 processor receives the user ID information, it may transmit that information from transmitter/receiver of user identification query module 50 to communications device 2. At step 414 application 2A on communication device 2 is launched in an inactive mode.

In an alternative embodiment, the user's IS information may be conveyed back to a central location via a wireless or other signal for verification. Once received at the remote location, the remote location sends instructions to vehicle 5 to transmit the signal at step 412 to the communications device 2. This embodiment may be used with such vehicle assistance systems as OnStar™ which utilizes a wireless air interface to allow the user to connect to a third party service provider for vehicle monitoring and/or assistance.

In an other embodiment, the vehicle itself may communication over a wide area network such as the Internet via a wireless interface and verify the user information from a remote location or server. In this embodiment, the user information and or profile may be entered and collected from over the internet, utilizing the world wide web, and a user interface.

FIG. 4C depicts an embodiment where the user id module is integrated into vehicle 5 and utilizes user input information to serve as a source of user identification. At step 420, the user may enter the vehicle 5. In an embodiment, the user must enter user specific identification information via a user interface such as a keypad or other input device. The user identification information entered at step 422 may be necessary to start the vehicle or to place the vehicle into an operating condition. Once the ID information is entered via a keypad or other sensor, at step 424 a signal is generated via a processor and transmitted to the communications device 2 via the transmitter/receiver of user identification query module 50. At step 426, application 2A is launched on the user's communications device 2.

Additionally and or alternatively, in an embodiment, regardless of the input methods described with respect to FIGS. 4A-C, an additional step depicted as step 428 may result, wherein the user's communications device 2 can autonomously send a predefined message from the communications device to a preselected recipient indicating that the user is operating vehicle 5. The message may be in the form of a text, voice message, e-mail or other message format.

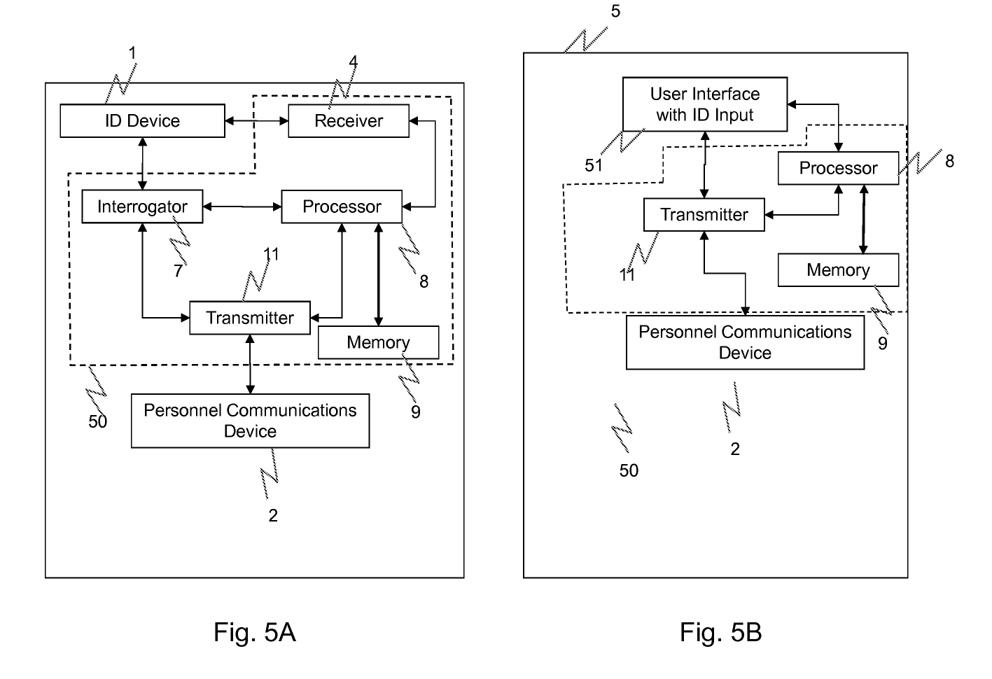

FIG. 5A depicts the use of an ID device in within the vehicle 5. Id device 1 may be passive or active device. Within vehicle 5 is a user identification query module 50 which may comprise receiver 4, interrogator 7, processor 8, memory 9 and transmitter 11. Transmitter 11 and receiver 4 may be a combined transceiver or separate transmitter and receiver components. Likewise, processor 8 may comprise memory 9 or they may be separate. Additionally or alternatively, these components need not be dedicated to one specific task and may be utilized by other systems within the vehicle 5. Interrogator 7 may be used when ID device 1 is a passive device. Additionally and or alternatively, interrogator 7 may be incorporated directly into the functionality of transmitter 11. Processor 8 may control interrogator 7, transmitter/receiver and other functionality related to the system. Processor 8 may be used in conjunction with memory 9 which may store software routine, passwords, user IDs, etc. In operation the user may bring the ID device and the Personal communications device within vehicle 5. If the ID device is passive the interrogator 7 under the control of processor 8 will trigger ID device 1 to transmit a signal which will be received by receiver 4. The information will be conveyed to processor 8 which will then have information related to the user and the user's ID Device and personal communications device. Transmitter 11 in response to instructions from processor 8 will transmit a signal which will be received by personal communications device 2 which will initialize the application or client to inhibit the functionality. If ID Device 1 is an active device, it may transmit a signal directly to the receiver 4 of user identification query module 50 which will then convey the information to processor 8 and transmitter 11.

FIG. 5B depicts an embodiment where rather than a separate user ID device 1, vehicle 5 is equipped with a user identification module 51 with an input. The input to identification module 51 may be a key pad, touch screen, or a biometric sensor such as a facial recognition, device, fingerprint device, voice recognition device. If transmitter 11 of user identification query module 50 detects the presence of personal communications device 2 it may require operator input information to energize the vehicle. Alternatively, the vehicle 5 may require the input of operator information to engage the engine or other portions of the vehicle, thereby inhibiting operation until a valid user ID is entered.

Once the user information is entered, the processor 8 identifies the user and instructs the transmitter 11 to send a signal to personal communications device 2 launching the application which will inhibit certain functionality.

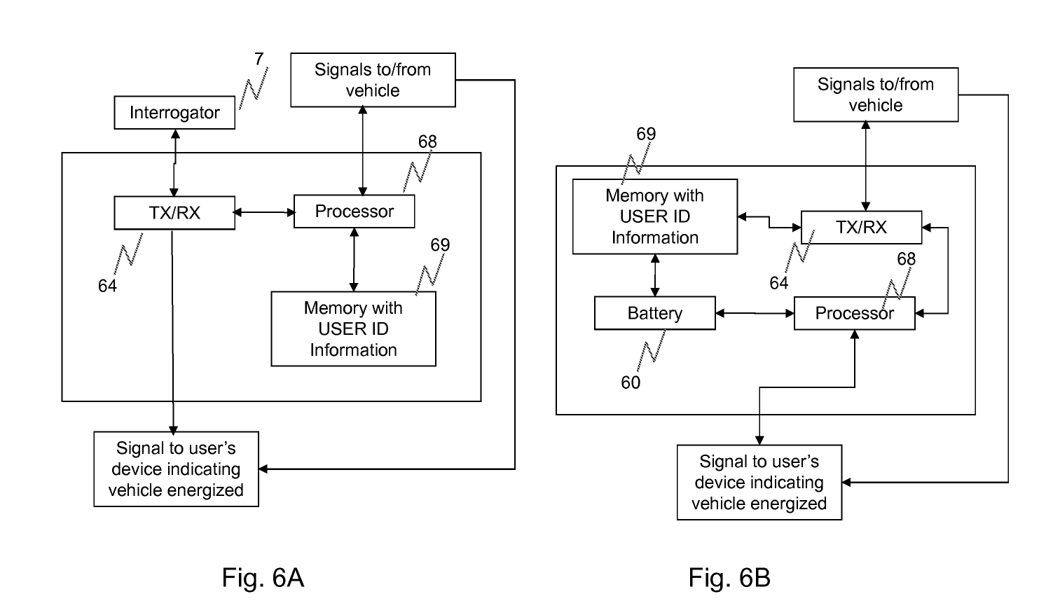

FIGS. 6A and 6B depict passive and active versions of a portable user ID device respectively. In version 6A the user ID device 1 may be in the form of a RFID card, chip, key fob or other small portable device. In an embodiment it is incorporated into the case of the personal communications device or worn by the user in the form of jewelry such as a bracelet or wrist band. It may be incorporated with other sensor information such as used in the personal fitness applications. Interrogator 7 which is located within vehicle 5 will generate the necessary power in the passive user ID 1 via induction, magnetism, microwave, etc., to cause processor 68 within the user ID 1 to retrieve from memory 69 the necessary information identifying the user to the vehicle processor 8 as is well known in the RFID art. A signal from the vehicle may then be conveyed to the user's personal communications device. Providing the necessary instructions from vehicle 5 to inhibit functionality of the user's personal communications device.

FIG. 6B depicts a powered user ID 1. Power for the circuitry of user ID 1 may be provided by battery 60. User device 1 may transmit its signal periodically, such that when it is within the vehicle it is detected such that the vehicle identifies the user ID within the vehicle and begins the steps necessary to inhibit the user's personal communications device. Additionally or alternatively, the active user ID device 1 could have a button to allow the user to send the user ID information to the vehicle via ID device transmitter/receiver 64

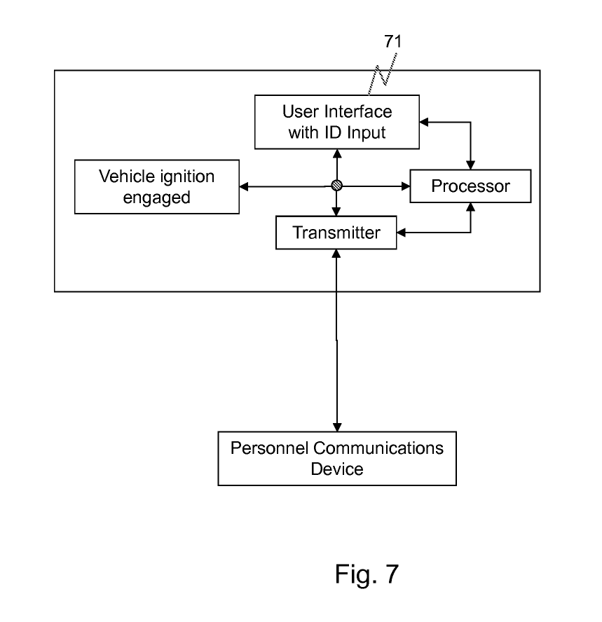

FIG. 7 depicts a user ID device 1 which is built into vehicle 5. User interface 71 may have a keypad or biometric sensor or other sensor which identifies when a driver is in the vehicle and who is operating the vehicle. Processor 78 will take the information received from user ID device 71 and based on that information will send the instructions to transmitter 74 to send a command to the user's associated personal communications device, thereby launching the application on the user's personal communications device to inhibit certain functionality.

It will be appreciated by those skilled in the art, that the invention is not limited to the specific embodiments disclosed. Changes and modifications to the various input devices, and ID devices may be used without departing from the invention.

We claim:

1. A method for inhibiting functionality of a personal communications device of a user within a moving vehicle, the method comprising:
determining, via a user identification device, if the user is in proximity to the vehicle;
obtaining, from the user identification device, user personal information associated with the user;
determining, based on the user personal information, if the user is operating the vehicle;
associating, based on the obtained information, the user with the user's personal communications device;
communicating, via a communications interface, with the user's communications device;
determining if the user's communications device is in motion; and
inhibiting, via a client installed on the user's communications device, operation of certain features of the user's communication device based on the determining.

2. A system for inhibiting functionality of a personal communications device of a user within a moving vehicle, the system comprising:
a user identification device comprising user personal information;
a user identification module within the vehicle for obtaining the user's personal information;
a processor for determining if the user is operating the moving vehicle;
a transmitter/receiver for transmitting/receiving information to/from the vehicle and the user's personal communications device;
a client installed on the user's communications device for inhibiting functionality on the personal communications device.

3. The system of claim 2 wherein the user identification device is a smart key.

4. The system of claim 2 wherein the user identification device is an identification unit.

5. The system of claim 4 where the identification unit utilizes a biometric measurement to identify the user.

6. The system of claim 4 where the identification unit utilizes a password to identify the user.

7. The system of claim 2 wherein the client inhibits all functionality on the communications device when the user is operating the vehicle and the vehicle is in motion.

8. The system of claim 2 wherein the client inhibits use of the keypad inputs on the personal communications device.

9. The system of claim 2 wherein the client inhibits e-mail and texting features of the personal communications device.

10. The system of claim 2 wherein the user personal information identifies the user's personal communications device.

11. The method of claim 1 wherein the inhibited operation of certain features of the user's communication device are restored when it is determined that the user's communications device is no longer in motion.

12. The method of claim 1 wherein the inhibited operation of certain features of the user's communication device are restored when it is determined that the user is no longer operating the moving vehicle.

13. The system of 2 wherein the client can be overridden by an emergency input.

14. The system of claim 2 wherein the client sends a communication whenever the client is overridden.

15. The method of claim 1 further comprising identifying the user of the vehicle to a third party via a communication at the time the user is operating the vehicle.
